(19) United States
(12) Patent Application Publication
(10) Pub. No.: US 2006/0293075 A1
(43) Pub. Date: Dec. 28, 2006

(54) Method to improve outer loop power control

(75) Inventors: Antii Kansakoski, Oulu (FI); Petri Komulainen, Oulu (FI); Arto Lehti, Oulu (FI); Simo Kaleva, Kiiminki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/417,168

(22) Filed: May 4, 2006

Related U.S. Application Data
(60) Provisional application No. 60/677,329, filed on May 4, 2005.

(51) Int. Cl. H04B 7/00; H04Q 7/20

(52) U.S. Cl. 455/522

(57) ABSTRACT

A method, apparatus and system for improving outer loop power control in a communications system. A quality value for a plurality of data channels is adjusted for the plurality of data channels, while maintaining a target value.

### BACKGROUND OF THE INVENTION

1. Field of the Invention

This invention relates to downlink power control.

2. Description of the Related Art

In a wireless communication system, a user with a terminal such as a cellular phone communicates with another user via transmissions on the downlink and uplink through one or more base stations. The downlink or forward link refers to transmission from the base station to the terminal, and the uplink or reverse link refers to transmission from the terminal to the base station. The downlink and uplink are typically allocated different frequencies.

Down link power control in W-CDMA systems consists of inner loop and outer loop, power control loops. The function of the inner loop power control is to maintain down link signal quality at a defined target value, such as a Signal to Interference (SIR) target or a bit error rate (BER). The outer loop power control tries to maintain the desired quality performance of the received transport channel at a defined quality target by adjusting the inner loop SIR target. The transport channel quality target is defined as Block Error Rate (BLER) and is signalled to user equipment (UE) by the UMTS Terrestrial Radio Access Network (UTRAN). Typically, the response time of the inner loop is faster than the response time of the outer loop.

A downlink signal can consist of many transport channels, each of them having their own quality BLER target. Further, each of the transport channels can comprise of several transport formats. Depending on the amount of data to be transmitted, a different transport format may be used. For example, if the UTRAN has no control data to be sent to the UE, it may send only the 16 cyclic redundancy check (CRC) bits. In case of control messages, the transport block length is 148 data bits+16 CRC bits=164 bits.

The W-CDMA standard currently permits one target BLER to be specified by the base station for each transport channel, regardless of the number of transport formats that may be selected for use for the transport channel. Each transport format may be associated with a different code block length, which may in turn require a different target SIR to achieve the target BLER. For W-CDMA, the code block length is determined by the transport block size, which is specified by the transport format. In W-CDMA, one or more transport channels are multiplexed together in a single physical channel, whose transmit power is adjusted through power control. Using the conventional power control mechanism, the inner power control loop would adjust the target SIR based on the received transport blocks to achieve the target BLER or better for each transport channel.

Since different transport formats may require different target SIRs to achieve the target BLER, the average transmit power for the physical channel may fluctuate depending on the specific sequence of transport formats selected for use in the constituent transport channels. Since outer and inner loops take some amount of time to converge, each time the transport format is changed, a transient occurs until the loops converge on the target SIR for the new transport format. During this transient time, the actual BLER may be much greater or less than the target BLER which would then result in degraded performance and lower system capacity.

The BLER quality target is transport channel specific. The different transport formats within the transport channel can have very different BLER performance. Typically, transport formats which contain less data, have better BLER performance than the transport formats with longer transport block lengths, because the shorter data blocks can reach the quality target BLER with a lower SIR target. As a result, the SIR target can start to fluctuate as a function of the transmitted transport format.

In addition, the different properties of the transport formats must be taken into account. As a result of these properties, the SIR target fluctuates and error bursts occur when the transport format is changed.

### SUMMARY OF THE INVENTION

The present invention includes embodiments for improving outer loop power control. According to one example embodiment, a method for improving power control is described. The method includes processing data for transmission on a plurality of data channels, wherein each of the plurality of data channels comprises one of a plurality of transport formats, and each transport format has a specific block length. The method further includes acquiring an initial quality value for the plurality of transport channels. The method further includes adjusting the quality value for each remaining transport channel of the plurality of transport channels and transmitting the data to maintain a target signal quality value.

According to another example embodiment of the invention, a system for improving outer loop power control is described. The system for improving power control includes a processor that processes data for transmission on a plurality of data channels, wherein each of the plurality of data channels comprises one of a plurality of transport formats, and each transport format has a specific block length. The system further includes a module that acquires an initial quality value for the plurality of data channels. The system further includes a module that adjusts the quality value for each remaining data channel of the plurality of data channels and a module that transmits the data to maintain a target signal quality value.

According to another example embodiment of the invention, an apparatus for improving outer loop power control is described. The apparatus includes processor means for processing data for transmission on a plurality of data channels, wherein each of the plurality of data channels comprises one of a plurality of transport formats, and each transport format has a specific block length. The apparatus further includes a determining means for determining an initial quality value for the plurality of transport channels. The apparatus further includes an adjusting means for adjusting the quality value for each remaining transport channel of the plurality of transport channels based on a predetermined block length criteria and a transmitter means for transmitting the data to maintain a target signal quality value.

### BRIEF DESCRIPTION OF THE DRAWINGS

FIG. 1 is an exemplary block diagram of a wireless system;

FIG. 2 represents outer and inner loop power control;

FIGS. 3A and 3B illustrate two different transport formats that may be used for two different transport channels;

FIG. 4 is a flow diagram of an exemplary embodiment of the present invention; and

FIG. 5 is a block diagram of a system according to an exemplary embodiment of the present invention.

### DETAILED DESCRIPTION OF THE PREFERRED EMBODIMENT(S):

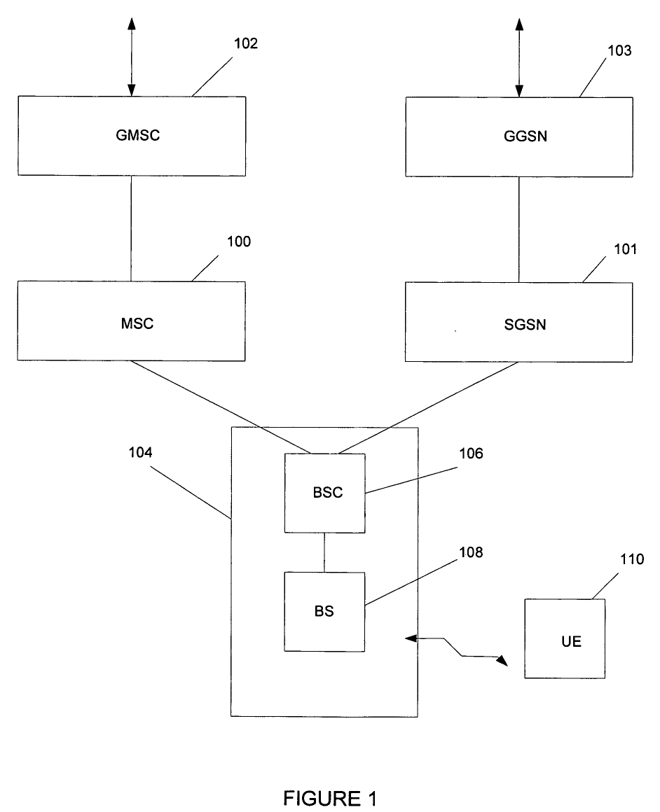

FIG. 1 illustrates an example of a structure of a radio system. The radio system can be based on, for example, UMTS (Universal Mobile Telephone System) or Wide-band Code Division Multiple Access (WCDMA).

The core network may, for example, correspond to the combined structure of the GSM (Global System for Mobile Communications) and GPRS systems. The GSM network elements may be responsible for the implementation of circuit-switched connections, and the GPRS network elements for the implementation of packet-switched connections. Some of the network elements may be, however, shared by both systems.

A mobile services switching center (MSC) 100 may enable circuit-switched signaling in the radio system. A serving GPRS support node (SGSN) 101 in turn may enable packet-switched signaling. All traffic in the radio system may be controlled by the MSC 100.

The core network may have a gateway unit 102, which represents a gateway mobile service switching center (GMSC) for attending to the circuit-switched connections between the core network and external networks, such as a public land mobile network (PLMN) or a public switched telephone network (PSTN). A gateway GPRS support node (GGSN) 103 may attend to the packet-switched connections between the core network and external networks, such as the Internet.

In this example, the MSC 100 and the SGSN 101 are connected to a radio access network (RAN) 104, which may include at least one base station controller 106 controlling at least one base station 108. The base station controller 106 can also be called a radio network controller, and the base station can be called a node B. A user terminal 110 communicates with at least one base station 108 over a radio interface.

In this example, the user terminal 110 can communicate with the base station 108 using a GPRS method. Data in packets contain address and control data in addition to the actual traffic data. Several connections may employ the same transmission channel simultaneously. A packet-switching method may be suitable for data transmission where the data to be transmitted is generated in bursts. In such a case, it is not necessary to allocate a data link for the entire duration of transmission but only for the time it takes to transmit the packets. This reduces costs and saves capacity considerably during both the set-up and use of the network.

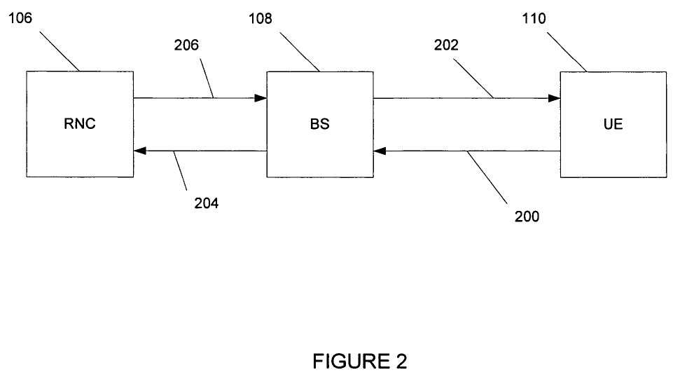

FIG. 2 represents outer and inner loop power control. When the user equipment (UE) 110 transmits a signal 200, such as a packet, to a base station 108, the base station 108 may form a SIR (Signal-to-Interference Ratio) estimate of the received signal. The base station may compare the SIR estimate to a target SIR, and transmit a signal 202 with a command, which depends on the comparison. If the value of the SIR estimate is smaller than the value of the target SIR, the base station 108 may command the user terminal 110 to increase its transmission power. If, on the other hand, the SIR estimate is higher than the target SIR, the base station may command the user terminal to decrease its transmission power.

The base station 108 sends the radio network controller 106 a signal 204 having information on the quality of the connection. The quality can be the quality of service and the information can indicate frame reliability, which can be based on the use of a reliability indicator. The reliability indicator can be CRC, estimated BER, soft information from a decoder, E.sub.b/N.sub.0, etc.

Typically, the target SIR can be changed by an outer-loop power control algorithm. The radio network controller 106 in turn may send the base station 108 a signal 206 which effects the target SIR according to the outer-loop power control algorithm. If the value of the quality of service is below a quality target value, which is true in the case of a failure in the reception of a packet, the radio network controller 108 may increase the target SIR in the base station 108. As a result of this, the average transmission power of a retransmission of a packet is higher than during the first transmission of the packet, assuming that the interference level is the same. The interference may also be considered to include noise. If the value of the quality of service is above a target value, the radio network controller 108 decreases the target SIR in the base station 108, which lowers the average transmission power with respect to interference. This takes place when a packet is received successfully.

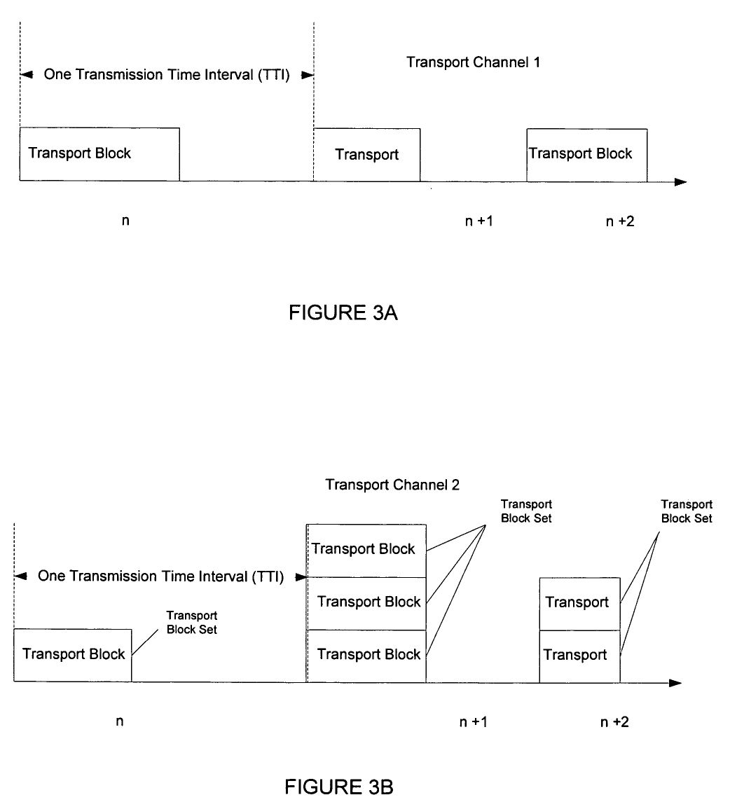

FIGS. 3A and 3B illustrates an example of two different transport formats that may be used for two different transport channels. As noted above, each transport channel may be associated with a respective transport format set, which includes one or more transport formats available for use for the transport channel. Each transport format defines, among other parameters, the size of the transport block and the number of transport blocks in a transmission time interval (TTI).

FIG. 3A illustrates a transport format set whereby one transport block is transmitted for each TTI, with the transport blocks for different transport formats having different sizes. This transport format set may be used, for example, for voice service whereby an adaptive multi-rate (AMR) speech coder may be used to provide a full rate (FR) frame, a silence descriptor (SID) frame, or a no-data (NULL or DTX) frame every 20 msec depending on the speech contents. The TTI can then be selected as 20 msec. FR frames are provided during periods of active speech, and a SID frame is typically sent once every 160 msec during periods of silence (i.e., pauses). In general, shorter transport blocks may be sent when there is no (or less) voice activity and longer transport blocks may be sent when there is (more) voice activity. The NULL frame is sent during periods of silence when SID is not sent.

FIG. 3B illustrates a transport format set whereby one or more transport blocks are transmitted for each TTI, with the transport blocks for different transport formats having different sizes. This transport format set may be used, for example, to support multiple services on a given transport channel. For example, a non-realtime service (e.g., packet data) may be multiplexed with a realtime service (e.g., voice). In this case, additional transport blocks may be used to support the non-realtime service when and as needed.

The W-CDMA standard defines a channel structure capable of supporting a number of users and designed for efficient transmission of various types of data. As noted above, in accordance with the W-CDMA standard, data to be transmitted to each terminal is processed as one or more transport channels at a higher signaling layer, and the transport channel data is then mapped to one or more physical channels assigned to the terminal. The transport channels support concurrent transmission of different types of services (e.g., voice, video, packet data, and so on) for a number of users.

In the W-CDMA system, a downlink DPCH is typically assigned to each terminal for the duration of a communication. The downlink DPCH is used to carry one or more transport channels and is characterized by the possibility of fast data rate change (e.g., every 10 msec), fast power control, and inherent addressing to a specific terminal. The downlink DPCH is used to transmit user-specific data in a time-division multiplexed manner along with control data.

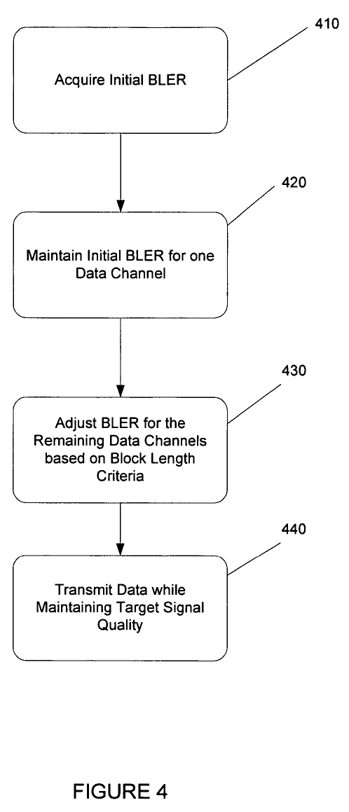

FIG. 4 is a flow diagram of the method according to an exemplary embodiment of the invention. As discussed above, each transport format has a different transport block length. Thus, within a given time period, there are a plurality of channels that transmit different transport formats, each format, with different block lengths.

At 410 the initial BLER target is acquired. As will be discussed below, the acquired BLER target is used to adjust the BLERs of the data channels. According to another exemplary embodiment of the invention, the BLER target is maintained for the identified transport format that has the longest transport block length 420. As discussed above, this would result in a higher SIR target for that particular transport format.

At 430 the BLER target is modified or adjusted for the remaining data channels so that the SIR target is the same for all of the transport formats. The BLERs are adjusted based in part on the initial An example of a means for modifying or adjusting the BLER targets for the remaining transport formats is discussed below.

According to this example, it is assumed that the bit error rate (BER) does not depend on the transport block length (L). Then the BLER is calculated based on the BER and the transport block length:

BLER=1−(1−ρ)², where ρ is the probability of a bit error.

If the transmitted BLER target is BLERₛ, the different transport formats of the transport channel are TFᵢ (i=1 . . . N) and the length of the transport blocks of the different transport formats is Lᵢ, then the modified BLER targets BLERᵢ is calculated by:

$${BLER}_{i} = {BLER}_{s} * \frac{1 - {( 1 - ρ )}^{Li}}{1 - {( 1 - ρ )}^{Lk}}$$

where Lₖ is the length of the longest transport block.

When ρ<<1.0, the above equation approximates to:

$${BLER}_{i} \approx {BLER}_{s} * \frac{Li}{Lk} .$$

As a result of this calculation, BLER is modified to a smaller value. Thus, the outer loop tracking speed will also be lowered. According to another exemplary embodiment of the invention, in order to avoid undesired slow outer loop convergence, a minimum allowed, i.e., floor BLER level such as around 0.1%, could be set for the BLERᵢ.

In another example embodiment of the invention an average block length is used instead of the largest block length. In still another example embodiment, a median block length is used instead of the largest block length.

As a result of modifying the BLER for the remaining block lengths, the SIR target is stabilized. The stabilized SIR target in turn, reduces error bursts that occur due to a drifting SIR target. Further, as a result of a stable SIR target, the outer loop is continuously operated since the updated rate of the loop does not depend on the transport format.

Referring again to FIG. 4, at the end of the process, the data is transmitted 440. As stated above, as a result of the example of the process discussed above, the SIR target is stabilized, which results in fewer error bursts.

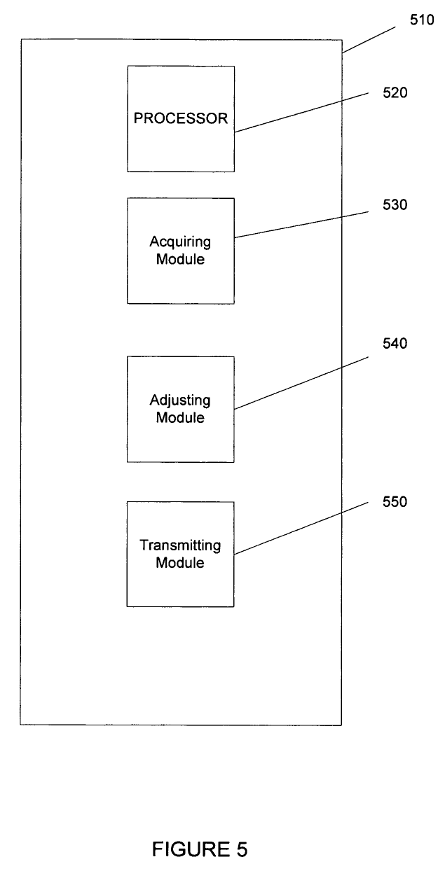

FIG. 5 is a block diagram of a system according to an exemplary embodiment of the present invention. According to this example, the system 510 includes four modules. The processor module 520 includes but is not limited to a central processing unit (CPU) or any other well-known circuit or module suitable for processing data.

The next module is the acquiring module 530. The acquiring module obtains the initial BLER that is transmitted to the system. As stated above, the initial BLER is the target value for all of the data channels. As stated above this obtained BLER is used to adjust the BLERs for the remaining data channels.

The next module of the system 510 is an adjusting module 540. As discussed above, the BLERs of the remaining data channels are adjusted according to the initial BLER and a predetermined block length criteria. For example, if the criteria is the transport format with the longest block length is determined to be the criteria for adjusting the remaining BLERs, that block length is used to calculate the BLER for each data channel. However, as stated above other block length criteria, such as an average block length or a median block length, for example, can be used to adjust the BLER for the data channels.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. For example, the invention could be implemented as hardware, software, a computer product comprising a computer readable medium, firmware and ASIC, or the like.

1. A method for improving power control in a communication system, the method comprising:
processing data for transmission on a plurality of data channels, wherein each of the plurality of data channels comprises one of a plurality of transport formats, and each transport format has a specific block length;
acquiring an initial quality value for the plurality of transport channels;
adjusting the quality value for each remaining transport channel of the plurality of transport channels; and
transmitting the data to maintain a target signal quality value.

2. The method of claim 1, further comprising maintaining the initial quality value for one of the plurality of transport channels;

3. The method of claim 1, wherein the quality value is a block error ratio (BLER).

4. The method of claim 1 wherein the target signal quality is a signal to interference ratio (SIR).

5. The method of claim 1, further comprising: identifying a transport format based on a predetermined block length criteria;
maintaining the determined quality value for a transport channel of the plurality of transport channels associated with the identified longest block length; and
adjusting the quality value for each remaining transport channel of the plurality of transport channels based on a block length criteria; and
transmitting the data to maintain a target signal quality value.

6. The method of claim 5, wherein adjusting the quality value for each of the remaining transport channel of the plurality of transport channels comprises calculating the quality value in accordance with the following formula:
$${BLER}_{i} = {BLER}_{s} * \frac{1 - {( 1 - ρ )}^{Li}}{1 - {( 1 - ρ )}^{Lk}}$$
where BLERᵢ is a quality value for transport channel i, BLERₛ is an initial quality value, ρ is a probability of a bit error, Lᵢ is a block length of transport channel i, Lₖ is a predetermined block length criteria.

7. The method of claim 6, wherein Lₖ is a longest block length of the plurality of block lengths

8. The method of claim 6, wherein Lₖ is one of an average block length or a median block length.

9. A method for improving power control in a communication system, the method comprising:
processing data for transmission on a plurality of data channels, wherein each of the plurality of data channels comprises one of a plurality of transport formats, and each transport format has a specific block length;
determining an initial block error ratio (BLER) for the plurality of data channels;
identifying a data channel from the plurality of data channels with a transport format that has a longest block length;
maintaining the initial BLER for the identified data channel;
adjusting the BLER for each remaining data channel of the plurality of data channels based on a predetermined block length criteria; and
transmitting the data to maintain a target signal to interference ratio (SIR).

10. A system for improving power control in a communication system, the system comprising:
a processor that processes data for transmission on a plurality of data channels, wherein each of the plurality of data channels comprises one of a plurality of transport formats, and each transport format has a specific block length;
a module that acquires an initial quality value for the plurality of data channels;
a module that adjusts the quality value for each remaining data channel of the plurality of data channels; and
a module that transmits the data to maintain a target signal quality value.

11. The system of claim 10, wherein the quality value is a block error ratio (BLER).

12. The system of claim 10, wherein the target signal quality is a signal to interference ratio (SIR).

13. The system of claim 10, further comprising:
a module that identifies a transport format with a longest block length;
a module that maintains the acquired quality value for a data channel of the plurality of data channels with the identified longest block length; and
a module that adjusts the acquired quality value for each remaining data channel of the plurality of data channels based on a predetermined block length criteria; and
a module that transmits the data to maintain a target signal quality value.

14. The system of claim 13, wherein the module that adjusts the quality value for each of the remaining data channel of the plurality of data channels, calculates the quality value in accordance with the following formula:
$${BLER}_{i} = {BLER}_{s} * \frac{1 - {( 1 - ρ )}^{Li}}{1 - {( 1 - ρ )}^{Lk}}$$
where BLERᵢ is a quality value for transport channel i, BLERₛ is an initial quality value, ρ is a probability of a bit error, Lᵢ is a block length of data channel i, Lₖ is a predetermined block length criteria within the plurality of data channels.

15. The system of claim 14, wherein Lₖ is a longest block length of the plurality of data formats.

16. The system of claim 14, wherein Lₖ is one of an average block length or a median block length of the plurality of data formats.

17. An apparatus for improving power control, the apparatus comprising: processor means for processing data for transmission on a plurality of data channels, wherein each of the plurality of data channels comprises one of a plurality of transport formats, and each transport format has a specific block length;
determining means for determining an initial quality value for the plurality of transport channels;
maintaining means for maintaining the initial quality value for one of the plurality of transport channels;
adjusting means for adjusting the quality value for each remaining transport channel of the plurality of transport channels based on a predetermined block length criteria; and
transmitter means for transmitting the data to maintain a target signal quality value.

18. The apparatus of claim 17, wherein the initial quality value is a block error ratio (BLER).

19. The apparatus of claim 17, wherein the target signal quality value is a signal to interference ratio (SIR).

20. The apparatus of claim 17, wherein the adjusting means adjusts the quality value for the remaining data channels by calculating the quality value for the remaining data channels based on the predetermined block length criteria being the longest block length of the plurality of transport formats.
